(19) United States
(12) Patent Application Publication
(10) Pub. No.: US 2026/0269097 A1
(43) Pub. Date: Sep. 10, 2026

(54) Noble Gas-Based Nuclear Voltaic Power Source Using Radioisotopes in Aerosol Form

(71) Applicant: NUBATT PTE. LTD., Singapore (SG)

(72) Inventors: Nima Golsharifi, London (GB); Mohamed Abdelbaset Ahmed, Florence (IT)

(21) Appl. No.: 19/557,213

(22) Filed: Mar. 5, 2026

(30) Foreign Application Priority Data
Mar. 6, 2025 (SG) 10202500577W

(51) Int. Cl. G21H 1/12; G01T 1/205; G21G 4/06

(52) U.S. Cl. CPC G21H 1/12; G01T 1/205; G21G 4/06

(57) ABSTRACT

A nuclear voltaic power source utilizing noble gases including xenon, krypton, argon, neon, and helium as scintillation converting media, combined with radioisotopes dispersed in aerosol form. Each noble gas produces characteristic excimer scintillation photons at specific emission wavelengths: xenon at 175 nm, krypton at 150 nm, argon at 128 nm, neon at 85 nm, and helium at 80 nm. These photons are absorbed by wide bandgap semiconductor converters (diamond, AlN, SiC, GaN, Ga2O3, BN, ZnO) matched to the emission wavelength of the selected noble gas. The aerosol particle size is optimized for each radioisotope-noble gas combination. Noble gas mixtures may be employed to tailor scintillation properties. Multiple cells with different noble gases may be combined for optimized power output. The system provides versatile, efficient, and long-lived nuclear voltaic power generation.

### CROSS-REFERENCE TO RELATED APPLICATIONS

This application claims the benefit of priority to Singapore Patent Application No. 10202500577W, filed Mar. 6, 2025, entitled “Noble Gasses-Based Nuclear Voltaic Power Source Using Radioisotopes in Aerosol Form,” the entire disclosure of which is hereby incorporated by reference.

### FIELD OF THE INVENTION

The present invention relates to nuclear power generation, and more specifically to a nuclear voltaic power source that utilizes one or more noble gases, including xenon, krypton, argon, neon, and helium, as scintillation converting media in combination with radioisotopes dispersed in aerosol form to convert nuclear radiation energy into electrical power via excimer-mediated photon generation and subsequent wide bandgap semiconductor photovoltaic conversion.

### BACKGROUND OF THE INVENTION

Nuclear voltaic systems convert kinetic energy from radioactive decay into electrical energy. Conventional approaches employ solid-state semiconductor converters placed adjacent to solid radioisotope sources. These configurations suffer from radiation damage to the semiconductor lattice, limited geometric interaction between the radiation source and converter, and self-absorption losses in the radioisotope layer.

Noble gases offer a family of scintillation media with a range of emission wavelengths, scintillation yields, and stopping powers. When ionizing radiation interacts with a noble gas, it produces excited-state dimers (excimers) that emit ultraviolet or vacuum ultraviolet photons as they relax to the ground state. Each noble gas has characteristic scintillation properties: xenon emits at approximately 175 nm, krypton at approximately 150 nm, argon at approximately 128 nm, neon at approximately 85 nm, and helium at approximately 80 nm. This family of emission wavelengths provides design flexibility for matching with different wide bandgap semiconductor converters.

Dispersing radioactive material as fine aerosol particles within a scintillating noble gas medium provides a volumetric interaction geometry that maximizes the radiation-gas interaction cross-section. Unlike planar solid-state configurations, the aerosol-in-gas configuration enables radiation emission in all directions from each suspended particle, with the surrounding gas medium capturing energy from every emission angle.

However, prior nuclear battery concepts using noble gas scintillators have been limited to single-gas systems, have not specified optimal aerosol particle sizes for specific radioisotope-gas combinations, and have not described the systematic selection of noble gas type based on emission wavelength matching with specific wide bandgap semiconductor converters. The present invention addresses these gaps by providing a generalized noble gas-based nuclear voltaic platform.

### SUMMARY OF THE INVENTION

The present invention provides a nuclear voltaic power source comprising: (a) at least one radioisotope dispersed in aerosol form; (b) at least one noble gas scintillation converting medium selected from xenon (Xe), krypton (Kr), argon (Ar), neon (Ne), and helium (He); (c) at least one wide bandgap semiconductor converter for absorbing scintillation photons generated by noble gas excimers and converting them into electron-hole pairs; (d) electrical contacts for charge extraction; and (e) a containment and radiation shielding structure.

The noble gas may be selected based on its scintillation yield, emission wavelength, decay time, stopping power, and compatibility with the chosen radioisotope and semiconductor converter. The system is operable at pressures ranging from sub-atmospheric to several atmospheres and at temperatures ranging from cryogenic to moderate ambient temperatures, depending on the selected noble gas.

### BRIEF DESCRIPTION OF THE DRAWINGS

FIG. 1 is a cross-sectional view of the spherical nuclear voltaic power source showing the containment structure, noble gas medium with dispersed radioisotope aerosol, wide bandgap semiconductor layer, and electrical contacts.

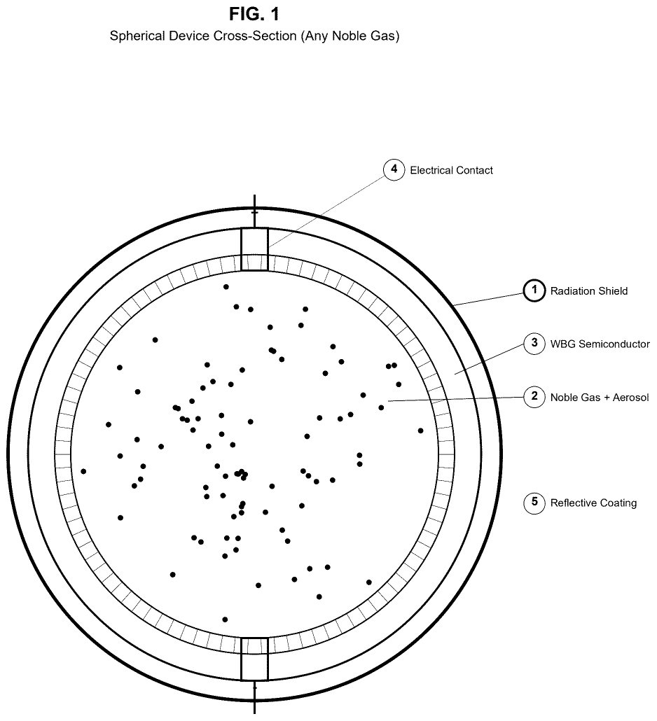

FIG. 2 is a table comparing scintillation properties of the five noble gases (Xe, Kr, Ar, Ne, He).

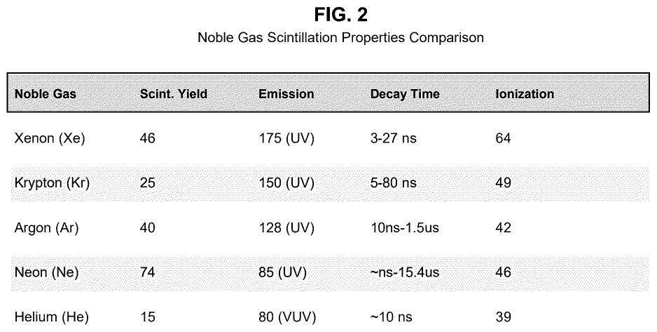

FIG. 3 is a schematic diagram showing the three-stage energy conversion pathway applicable to all noble gas embodiments.

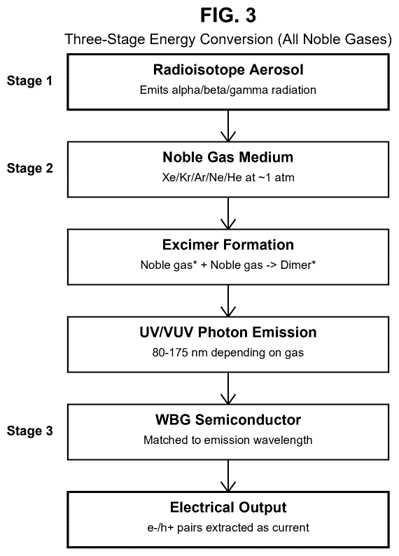

FIG. 4 is a table comparing physical properties of the five noble gases at standard pressure.

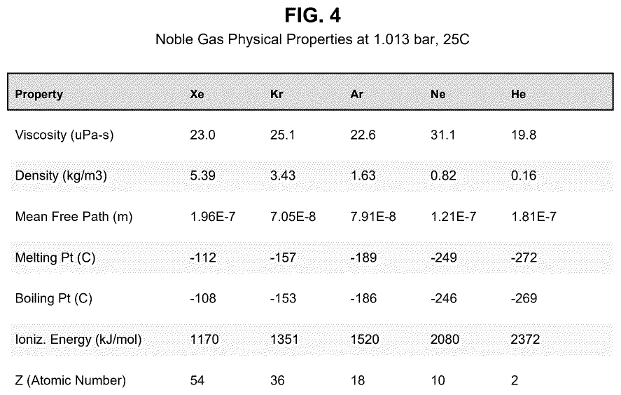

FIG. 5 is a table showing optimal aerosol particle radii for various radioisotopes in xenon gas.

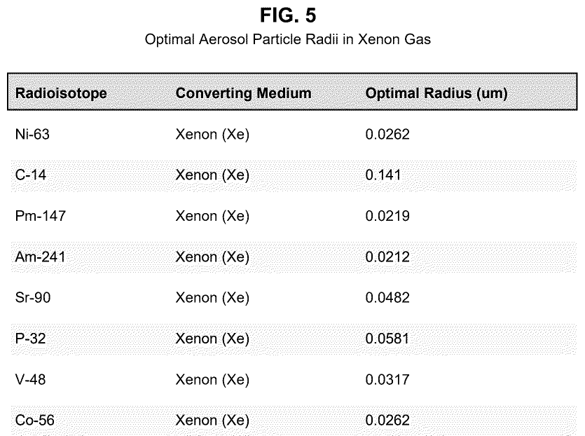

FIG. 6 is a cross-sectional view of a planar device configuration.

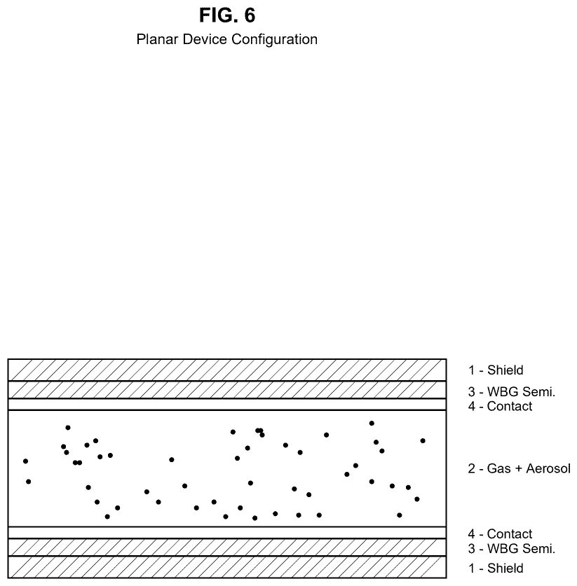

FIG. 7 is a cross-sectional view of a cylindrical device configuration.

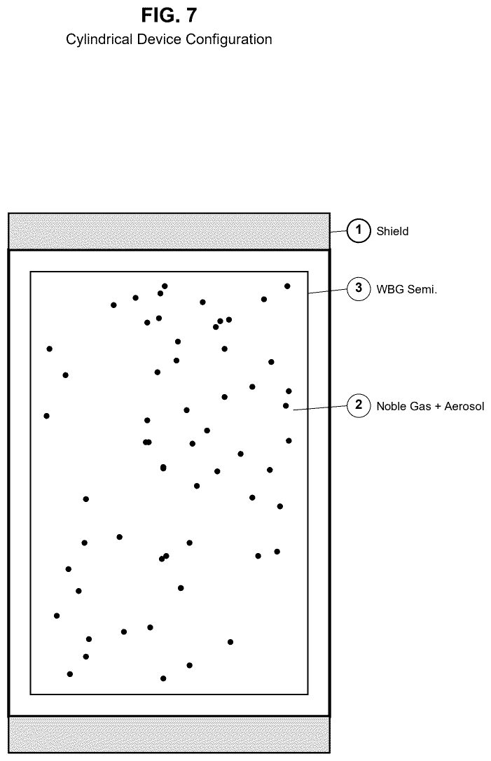

FIG. 8 is a parts reference table listing all reference numerals.

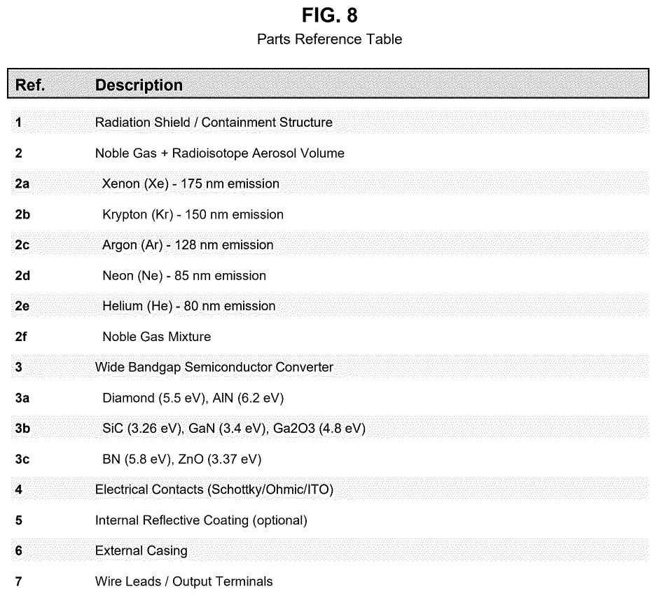

FIG. 9 is a diagram showing emission wavelength matching between noble gases and wide bandgap semiconductors.

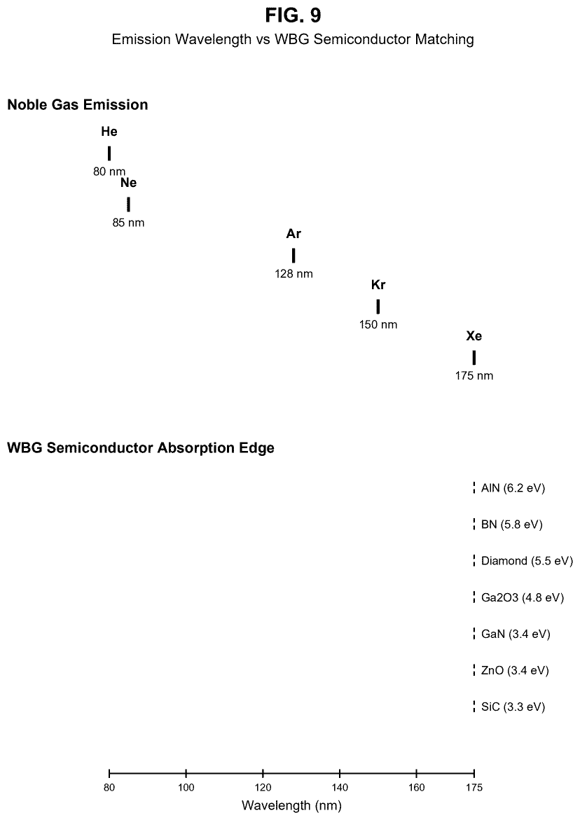

FIG. 10 is a schematic showing a series-parallel cell array for scalable power output.

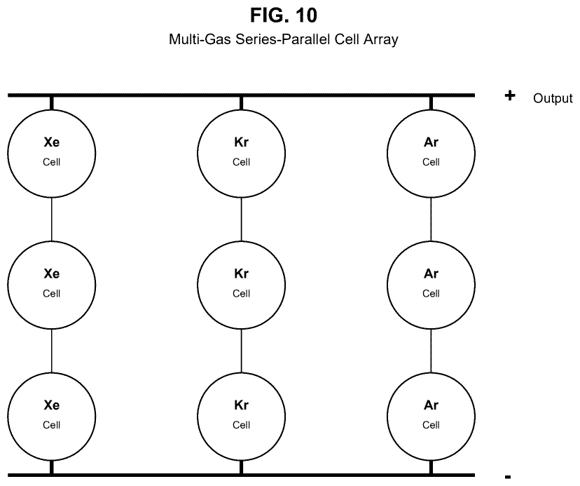

### DETAILED DESCRIPTION OF THE INVENTION

### Noble Gas Scintillation Converting Media

The system utilizes at least one noble gas as a converting medium to contain radioisotopes in aerosol form and convert emitted high-energy radiation into photons. Each noble gas has characteristic scintillation properties as follows:
Xenon (Xe): scintillation yield of approximately 46 photons per keV, emission wavelength of approximately 175 nm (UV), scintillation decay time of 3 to 27 nanoseconds, ionization yield of approximately 64 electron-ion pairs per keV, gas density of approximately 5.39 kg/m3, and viscosity of approximately 23 microPascal-seconds at standard pressure.
Krypton (Kr): scintillation yield of approximately 25 photons per keV, emission wavelength of approximately 150 nm (UV), scintillation decay time of 5 to 80 nanoseconds, ionization yield of approximately 49 electron-ion pairs per keV, gas density of approximately 3.43 kg/m3, and viscosity of approximately 25 microPascal-seconds at standard pressure.
Argon (Ar): scintillation yield of approximately 40 photons per keV, emission wavelength of approximately 128 nm (UV), scintillation decay time of 10 nanoseconds to 1.5 microseconds, ionization yield of approximately 42 electron-ion pairs per keV, gas density of approximately 1.63 kg/m3, and viscosity of approximately 23 microPascal-seconds at standard pressure.
Neon (Ne): scintillation yield of approximately 74 photons per keV, emission wavelength of approximately 85 nm (UV), scintillation decay time of a few nanoseconds to 15.4 microseconds, ionization yield of approximately 46 electron-ion pairs per keV, gas density of approximately 0.82 kg/m3, and viscosity of approximately 31 microPascal-seconds at standard pressure.
Helium (He): scintillation yield of approximately 15 photons per keV, emission wavelength of approximately 80 nm (VUV), scintillation decay time of approximately 10 nanoseconds, ionization yield of approximately 39 electron-ion pairs per keV, gas density of approximately 0.16 kg/m3, and viscosity of approximately 20 microPascal-seconds at standard pressure.

The noble gas selection is based on matching the emission wavelength to the absorption characteristics of the wide bandgap semiconductor converter, optimizing the scintillation yield for the target application power level, and ensuring compatibility with the operating temperature and pressure constraints.

### Radioisotope Aerosol

The radioisotope is dispersed as fine particles in aerosol form within the noble gas. Suitable radioisotopes include, but are not limited to: Ni-63, C-14, Pm-147, Am-241, Sr-90, P-32, V-48, Co-56, Co-60, Cs-137, H-3, Kr-85, Po-210, Pu-238, Fe-55, and combinations thereof.

The aerosol particle size is optimized for each radioisotope-noble gas combination. Exemplary optimal particle radii in xenon include: Ni-63 (0.0262 micrometers), C-14 (0.141 micrometers), Pm-147 (0.0219 micrometers), Am-241 (0.0212 micrometers), Sr-90 (0.0482 micrometers), P-32 (0.0581 micrometers), V-48 (0.0317 micrometers), and Co-56 (0.0262 micrometers). The optimal particle size varies with the noble gas selection due to differences in gas density and stopping power.

Stabilization measures, such as the use of stabilizers for liquid aerosols or surface treatments for solid particles, may be employed to ensure that the aerosols remain well-dispersed and stable, preventing settling and ensuring efficient operation.

### Wide Bandgap Semiconductor Converter

The wide bandgap semiconductor converter is selected to match the emission wavelength of the chosen noble gas. Suitable materials include: silicon carbide (SiC, bandgap approximately 3.26 eV), zinc oxide (ZnO, bandgap approximately 3.37 eV), gallium nitride (GaN, bandgap approximately 3.4 eV), gallium oxide (Ga2O3, bandgap approximately 4.8 eV), diamond (bandgap approximately 5.5 eV), boron nitride (BN, bandgap approximately 5.8 eV), and aluminum nitride (AlN, bandgap approximately 6.2 eV).

For xenon (175 nm, 7.08 eV photons), diamond or AlN are preferred converters. For argon (128 nm, 9.69 eV photons), AlN is preferred due to its wider bandgap matching the higher photon energy. For neon or helium (85-80 nm, 14.6-15.5 eV photons), AlN or specialized UV-transparent converters may be employed.

### Electrical Contacts

Electrical contacts are provided for extracting photogenerated charge carriers. The contacts may include Schottky diode contacts formed from aluminum (work function approximately 4.28 eV), titanium (approximately 4.33 eV), gold (approximately 5.1 eV), nickel (approximately 5.15 eV), palladium (approximately 5.6 eV), and platinum (approximately 5.65 eV). Ohmic contacts may alternatively be employed using gold, titanium, nickel, aluminum, silver, or copper. Specialized contacts including indium tin oxide (ITO), graphene, molybdenum, tungsten, and chromium may be utilized for transparent or high-temperature applications.

### Containment Structure

The containment structure is designed as an enclosed vessel, preferably spherical, to hold the noble gas and radioisotope aerosol. The spherical geometry maximizes the solid angle of photon capture. The containment structure includes radiation shielding and maintains a gas-tight seal. An optional internal reflective coating may redirect unabsorbed photons toward the semiconductor converter.

### Noble Gas Mixtures

In certain embodiments, mixtures of two or more noble gases may be employed to tailor the scintillation properties. For example, a xenon-argon mixture may provide a combination of high stopping power (from xenon) with enhanced scintillation yield characteristics. The emission wavelength of such mixtures may be intermediate between the pure gas emission wavelengths, providing additional design flexibility for semiconductor converter matching.

What is claimed is:

1. A nuclear voltaic power source comprising:
(a) at least one radioisotope dispersed in aerosol form;
(b) at least one noble gas scintillation converting medium selected from the group consisting of xenon, krypton, argon, neon, helium, and combinations thereof, the noble gas producing excimer scintillation photons upon interaction with ionizing radiation from the radioisotope;
(c) at least one wide bandgap semiconductor converter disposed to receive the excimer scintillation photons and convert them into electron-hole pairs;
(d) electrical contacts for extracting current from the wide bandgap semiconductor converter; and
(e) a containment structure enclosing the noble gas and the radioisotope aerosol and providing radiation shielding.

2. The nuclear voltaic power source of claim 1, wherein the noble gas is xenon having a scintillation yield of approximately 46 photons per keV and an emission wavelength of approximately 175 nm.

3. The nuclear voltaic power source of claim 1, wherein the noble gas is krypton having a scintillation yield of approximately 25 photons per keV and an emission wavelength of approximately 150 nm.

4. The nuclear voltaic power source of claim 1, wherein the noble gas is argon having a scintillation yield of approximately 40 photons per keV and an emission wavelength of approximately 128 nm.

5. The nuclear voltaic power source of claim 1, wherein the noble gas is neon having a scintillation yield of approximately 74 photons per keV and an emission wavelength of approximately 85 nm.

6. The nuclear voltaic power source of claim 1, wherein the noble gas is helium having a scintillation yield of approximately 15 photons per keV and an emission wavelength of approximately 80 nm.

7. The nuclear voltaic power source of claim 1, wherein the wide bandgap semiconductor converter is selected from the group consisting of diamond, aluminum nitride, silicon carbide, gallium nitride, gallium oxide, boron nitride, and zinc oxide.

8. The nuclear voltaic power source of claim 1, wherein the wide bandgap semiconductor converter is selected based on matching its absorption characteristics to the emission wavelength of the selected noble gas.

9. The nuclear voltaic power source of claim 1, wherein the radioisotope aerosol comprises particles having a size optimized for the selected radioisotope and noble gas combination to maximize radiation emission into the noble gas while maintaining aerosol stability.

10. The nuclear voltaic power source of claim 1, wherein the containment structure has a spherical geometry and includes an optional internal reflective coating to redirect unabsorbed scintillation photons toward the wide bandgap semiconductor converter.

11. A method of generating electrical power from nuclear radiation, the method comprising:
(a) selecting a noble gas scintillation medium from the group consisting of xenon, krypton, argon, neon, helium, and combinations thereof based on its scintillation yield, emission wavelength, and compatibility with a target wide bandgap semiconductor converter;
(b) dispersing at least one radioisotope as aerosol particles within the selected noble gas;
(c) generating excimer scintillation photons by interaction of ionizing radiation from the radioisotope aerosol with the noble gas;
(d) absorbing the excimer scintillation photons in the wide bandgap semiconductor converter to generate electron-hole pairs; and
(e) extracting electrical current from the wide bandgap semiconductor converter through electrical contacts.

12. The method of claim 11, wherein step (a) comprises selecting xenon for applications requiring high stopping power, or selecting argon for applications requiring high scintillation yield at lower cost, or selecting neon for applications requiring highest photon yield per unit energy.

13. The method of claim 11, wherein step (b) further comprises selecting an aerosol particle size optimized for the specific radioisotope and noble gas combination.

14. The method of claim 11, wherein step (a) comprises selecting a mixture of two or more noble gases to tailor the scintillation properties for a target application.

15. The method of claim 11, further comprising enclosing the noble gas and radioisotope aerosol within a spherical containment structure lined with the wide bandgap semiconductor converter.

16. A nuclear voltaic power source comprising:
a containment vessel enclosing at least one noble gas selected from xenon, krypton, argon, neon, and helium;
a radioisotope aerosol uniformly dispersed within the noble gas, the aerosol comprising particles having an optimized size selected based on the radiation type and energy of the radioisotope and the density and stopping power of the selected noble gas;
a wide bandgap semiconductor converter selected to have an absorption edge matched to or below the emission wavelength of the excimer scintillation photons produced by the selected noble gas; and
electrical contacts for extracting photogenerated charge from the wide bandgap semiconductor converter.

17. The nuclear voltaic power source of claim 16, wherein the noble gas is xenon and the wide bandgap semiconductor converter comprises diamond or aluminum nitride.

18. The nuclear voltaic power source of claim 16, wherein the noble gas is argon and the wide bandgap semiconductor converter comprises aluminum nitride.

19. The nuclear voltaic power source of claim 16, wherein the radioisotope is selected from the group consisting of Ni-63, C-14, Pm-147, Am-241, Sr-90, P-32, Co-60, Cs-137, H-3, Po-210, Pu-238, and Fe-55.

20. The nuclear voltaic power source of claim 16, wherein the containment vessel has a spherical, cylindrical, or planar geometry.

21. A nuclear voltaic power source comprising:
a containment structure filled with a noble gas medium comprising a mixture of at least two noble gases selected from xenon, krypton, argon, neon, and helium;
a radioisotope dispersed as aerosol particles within the noble gas mixture;
a wide bandgap semiconductor converter disposed to receive scintillation photons generated by excimer formation in the noble gas mixture; and
electrical contacts for extracting photogenerated charge carriers from the wide bandgap semiconductor converter.

22. The nuclear voltaic power source of claim 21, wherein the noble gas mixture comprises xenon and argon.

23. The nuclear voltaic power source of claim 21, wherein the wide bandgap semiconductor converter is selected based on the emission wavelength characteristics of the noble gas mixture.

24. The nuclear voltaic power source of claim 21, wherein the relative proportions of the noble gases in the mixture are selected to optimize at least one of scintillation yield, emission wavelength, gas density, and stopping power for a target application.

25. The nuclear voltaic power source of claim 21, further comprising aerosol stabilization measures to maintain uniform radioisotope dispersion within the noble gas mixture.

26. A nuclear voltaic power system comprising:
a plurality of nuclear voltaic power cells, wherein at least two cells contain different noble gases selected from xenon, krypton, argon, neon, and helium;
each cell comprising a containment vessel, at least one radioisotope dispersed as aerosol within the noble gas, a wide bandgap semiconductor converter matched to the emission wavelength of the noble gas in that cell, and electrical contacts; and
an electrical interconnection connecting the plurality of cells in at least one of a series and a parallel configuration.

27. The nuclear voltaic power system of claim 26, wherein a first cell contains xenon and a second cell contains argon, providing different voltage-current output characteristics.

28. The nuclear voltaic power system of claim 26, wherein the electrical contacts comprise at least one of Schottky diode contacts, ohmic contacts, and specialized contacts selected from indium tin oxide, graphene, molybdenum, tungsten, and chromium.

29. The nuclear voltaic power system of claim 26, wherein the radioisotope aerosol in each cell comprises particles having a size independently optimized for the specific radioisotope-noble gas combination in that cell.

30. The nuclear voltaic power system of claim 26, wherein at least one cell comprises a combination of two or more different radioisotopes selected to provide complementary emission characteristics and optimized total energy output.
